(19) United States
(12) Patent Application Publication
(10) Pub. No.: US 2015/0046314 A1
(43) Pub. Date: Feb. 12, 2015

(54) Computerized System for Trading

(71) Applicant: Repasi Investments Pty Limited, Noosaville (AU)

(72) Inventor: Rolf Repasi, Noosa Heads (AU)

(73) Assignee: Repasi Investments Pty Limited, Noosaville (AU)

(21) Appl. No.: 14/455,519

(22) Filed: Aug. 8, 2014

Related U.S. Application Data
(60) Provisional application No. 61/864,025, filed on Aug. 9, 2013.

(51) Int. Cl. G06Q 40/04

(52) U.S. Cl. CPC G06Q 40/04
USPC 705/37

(57) ABSTRACT

A server processing system, method and computer readable medium for determining a trading entity for receiving a trade order. In one aspect the server processing system is configured to: receive client data from a plurality of client processing systems; store the client data received from the plurality of client processing systems in memory; receive parameters of a trade order; and determine, based on at least some of the client data stored in memory and parameters of the trade order, a preferred trading, wherein the trade order is transferred to the preferred trading entity to execute the trade. Additionally, the server processing system can manage and maintain a fund where suitable users are identified based on the client data to place a trade order on behalf of the fund. Other users are able to invest in the fund.

### RELATED APPLICATIONS

This application claims priority to and the benefit of U.S. Provisional Application No. 61/864,025, filed on Aug. 9, 2013, the entire disclosure of which is incorporated by reference herein.

### BACKGROUND OF THE INVENTION

### Field of Invention

The present invention relates to a server processing system, client processing system, system, method and computer readable medium of executable instructions for trading.

Currently, online trading systems suffer from a number of problems.

Currently it is difficult and time consuming for retail investors to obtain objective metrics, comparisons and rankings of trading entities such as brokers and Electronic Communication Networks (ECNs) for receiving a trade order. Generally, current trading platform provide no such metric or the like.

Factors such as slippage and pricing differentials can pose significant factors in relation to profitability of a trade for an investor. This can particularly be problematic when a trade order may be placed relatively quickly due to recent events in the market where it simply is not possible to manually obtain pricing data from each trading entity and determine the most optimum one or more trading entities to select for receiving the trade order.

Furthermore, generally retail investors cannot invest in a hedge fund using current online trading platforms used for making typical trades of stock/shares. In particular, hedge funds are made available only to certain sophisticated or accredited investors and cannot be offered or sold to the general public.

Therefore, it would be desirable to alleviate one or more of the above-mentioned problems or at least provide a commercial alternative.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF INVENTION

10 In a first aspect there is provided a server processing system for determining a trading entity for receiving a trade order, wherein the server processing system is configured to:
receive client data indicative of trade data for one or more trades by one ore more users of one or more client processing systems;
store the client data in memory;
receive parameters of a trade order; and
determine, based on at least some of the client data stored in memory and parameters of the trade order, a preferred trading entity from a plurality of available trading entities to receive the trade order thereby seeking to optimise the trade, wherein the trade order is transferred to a trading entity processing system of the preferred trading entity to execute the trade.

In certain embodiments the trade data is indicative of:
one or more respective trading entities who executed the respective one or more previous trades;
a timestamp when one or more trade orders were sent to a respective trading entity for the one or more previous trades;
quoted pricing at the time the one or more trade orders were placed;
actual pricing for the respective one or more previous trades; and
total time to process the one or more trades.

In certain embodiments, at least some of the client data is indicative of a client processing system profile for each client processing system, wherein the server processing system is configured to:
determine a subset of the client data based on the client processing system profile; and
determine the preferred trading entity based on the subset of the client data.

In certain embodiments, the server processing system obtains pricing data from the plurality of available trading entities, wherein the server processing system is configured to determine the preferred trading entity further based on the pricing data.

In certain embodiments, the server processing system is configured to obtain at least some of the pricing data from the plurality of available trading entities at scheduled or detected volatile events, wherein in the event that the server processing system receives parameters of a trade order for a new scheduled or current volatile event, the server processing system determines the preferred trading entity based on the pricing data obtained for the scheduled or the detected volatile events.

In certain embodiments, the server processing system is configured to select multiple preferred trading entities from a plurality of available trading entities to receive the trade order.

In certain embodiments, the server processing system is configured to divide the trade order between the multiple preferred trading entities:
equally; or
unequally based on an evaluation of the multiple preferred trading entities for the trade order.

In certain embodiments, the server processing system is configured to manage a fund and trading system, wherein the server processing system is configured to:
perform quantitative analysis of the trade data, wherein the trade data is indicative of trades by a plurality of users;
identify a subset of the users based on results of the quantitative analysis and selection criteria;
transfer an invite to at least some of the users of the subset of users to join a fund managed by the server processing system; and
in the event that at least one of the users join the find, receive the trade order from the at least one of the users using one of the client processing systems for execution on behalf of the fund.

In a second aspect there is provided a non-transitory computer readable medium for configuring a server processing system for determining a trading entity for receiving a trade order, wherein the server processing system is configured by the computer readable medium to:
receive client data indicative of trade data for one or more trades by one ore more users of one or more client processing systems;
store the client data in memory;
receive parameters of a trade order; and
determine, based on at least some of the client data stored in memory and parameters of the trade order, a preferred trading entity from a plurality of available trading entities to receive the trade order thereby seeking to optimise the trade, wherein the trade order is transferred to a trading entity processing system of the preferred trading entity to execute the trade.

In certain embodiments, the trade data is indicative of:
one or more respective trading entities who executed the respective one or more previous trades;
a timestamp when one or more trade orders were sent to a respective trading entity for the one or more previous trades;
quoted pricing at the time the one or more trade orders were placed;
actual pricing for the respective one or more previous trades; and
total time to process the one or more trades.

In certain embodiments, the client data is indicative of a client processing system profile, wherein the server processing system is configured to:
determine a subset of the client data based on the client processing system profile; and
determine the preferred trading entity based on the subset of the client data.

In certain embodiments, the server processing system is configured to obtain pricing data from the plurality of available trading entities, wherein the server processing system is configured to determine the preferred trading entity further based on the pricing data.

In certain embodiments, the server processing system is configured to obtain at least some of the pricing data from the plurality of available trading entities at scheduled or detected volatile events, wherein in the event that the server processing system receive parameters of a trade order for a new scheduled or current volatile event, the server processing system determines the preferred trading entity based on the pricing data obtained for the scheduled or the detected volatile events.

In certain embodiments, the server processing system is configured to select multiple preferred trading entities from a plurality of available trading entities to receive the trade order.

In certain embodiments, the server processing system is configured to divide the trade order between the multiple preferred trading entities:
equally; or
unequally based on an evaluation of the multiple preferred trading entities for the trade order.

In certain embodiments, the server processing system is configured to manage a fund and trading system, wherein the server processing system is configured to:
perform quantitative analysis of the trade data, wherein the trade data is indicative of trades by a plurality of users;
identify a subset of the users based on results of the quantitative analysis and selection criteria;
transfer an invite to at least some of the users of the subset of users to join a fund managed by the server processing system; and
in the event that at least one of the users join the fund, receive the trade order from the at least one of the users using one of the client processing systems for execution on behalf of the fund.

In a third aspect there is provided a non-transitory computer readable medium for configuring a server processing system for determining a trading entity for receiving a trade order, wherein the server processing system is configured by the computer readable medium to:
receive client data indicative of trade data for one or more trades by one ore more users of one or more client processing systems;
store the client data in memory;
receive parameters of a trade order; and
determine, based on at least some of the client data stored in memory and parameters of the trade order, a preferred trading entity from a plurality of available trading entities to receive the trade order thereby seeking to optimise the trade, wherein the trade order is transferred to a trading entity processing system of the preferred trading entity to execute the trade.

In certain embodiments, the trade data is indicative of:
one or more respective trading entities who executed the respective one or more previous trades;
a timestamp when one or more trade orders were sent to a respective trading entity for the one or more previous trades;
quoted pricing at the time the one or more trade orders were placed;
actual pricing for the respective one or more previous trades; and
total time to process the one or more trades.

In certain embodiments, at least some of the client data is indicative of a client processing system profile for each client processing system, wherein the method includes the server processing system:
determining a subset of the client data based on the client processing system profile; and
determining the preferred trading entity based on the subset of the client data.

In certain embodiments, the method includes the server processing system:
obtaining pricing data from the plurality of available trading entities; and
determining the preferred trading entity further based on the pricing data.

In certain embodiments, the method includes the server processing system obtaining at least some of the pricing data from the plurality of available trading entities at scheduled or detected volatile events, wherein in the event that the server processing system receives parameters of a trade order for a new scheduled or current volatile event, the server processing system determines the preferred trading entity based on the pricing data obtained for the scheduled or the detected volatile events.

In certain embodiments, the method includes the server processing system selecting multiple preferred trading entities from a plurality of available trading entities to receive the trade order.

In certain embodiments, the method includes the server processing system dividing the trade order between the multiple preferred trading entities:
equally; or
unequally based on an evaluation of the multiple preferred trading entities for the trade order.

In certain embodiments, the method includes the server processing system managing a fund and trading system, wherein the method includes the server processing system:
performing quantitative analysis of the trade data, wherein the trade data is indicative of trades by a plurality of users;
identifying a subset of the users based on results of the quantitative analysis and selection criteria;
transferring an invite to at least some of the users of the subset of users to join a fund managed by the server processing system; and
in the event that at least one of the users join the fund, receiving the trade order from the at least one of the users using one of the client processing systems for execution on behalf of the fund.

In a fourth aspect there is provided a server processing system for managing a fund and trading system, wherein the server processing system is configured to:
receive trade data indicative of trades performed by a plurality of traders of the trading system;
perform quantitative analysis of the trade data;
identify a subset of the traders based on results of the quantitative analysis and selection criteria;
transfer an invite to at least some of the traders of the subset of traders to join a fund managed by the server processing system; and
in the event that at least one of the traders joins the fund, receive a trade order from the at least one of the traders for execution on behalf of the fund, wherein the trade order is received from a client processing system in data communication with the server processing system.

In certain embodiments, the trades are executed using actual or virtual currency.

In certain embodiments, in the event that the trade is to be executed using virtual currency, the server processing system is configured to:
identify, from the trade data, one or more executed trades using actual currency which are similar to the requested trade; and
use results of the identified executed trades using actual currency to simulate the trade using virtual currency.

In certain embodiments, the server processing system is configured to transfer the invite:
automatically; or
in response to receiving approval from the owner.

In a fifth aspect there is provided a method for managing a fund and trading system, wherein the method includes, in a server processing system, steps of:
receiving trade data indicative of trades performed by a plurality of traders of the trading system;
performing quantitative analysis of the trade data;
identifying a subset of the traders based on results of the quantitative analysis and selection criteria;
transferring an invite to at least some of the traders of the subset of traders to join a fund managed by the server processing system; and
in the event that at least one of the traders joins the fund, receiving a trade order from the at least one of the traders for execution on behalf of the fund, wherein the trade order is received from a client processing system in data communication with the server processing system.

In certain embodiments, the trades are executed using actual or virtual currency.

In certain embodiments, in the event that the trade is to be executed using virtual currency, the method includes, in the server processing system, steps of:
identifying, from the trade data, one or more executed trades using actual currency which are similar to the requested trade; and
using results of the identified executed trades using actual currency to simulate the trade using virtual currency.

In certain embodiments, the method includes the server processing system transferring the invite:
automatically; or
in response to receiving approval from the owner.

In a sixth aspect there is provided a non-transitory computer readable media for configuring a server processing system for managing a fund and trading system, wherein the server processing system is configured by the computer readable media to:
receive trade data indicative of trades performed by a plurality of traders of the trading system;
perform quantitative analysis of the trade data;
identify a subset of the traders based on results of the quantitative analysis and selection criteria;
transfer an invite to at least some of the traders of the subset of traders to join a fund managed by the server processing system; and
in the event that at least one of the traders joins the fund, receive a trade order from the at least one of the traders for execution on behalf of the fund, wherein the trade order is received from a client processing system in data communication with the server processing system.

In certain embodiments, the trades are executed using actual or virtual currency.

In certain embodiments, in the event that the trade is to be executed using virtual currency, the server processing system is configured to:
identify, from the trade data, one or more executed trades using actual currency which are similar to the requested trade; and
use results of the identified executed trades using actual currency to simulate the trade using virtual currency.

In certain embodiments, the server processing system is configured to transfer the invite:
automatically; or
in response to receiving approval from the owner.

Other aspects and embodiments will be appreciated throughout the details description.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 illustrates a functional block diagram of an example processing system that can be utilised to embody or give effect to a particular embodiment;

FIG. 2 illustrates an example network infrastructure that can be utilised to embody or give effect to a particular embodiment;

FIG. 3 illustrates a system diagram of a system for determining one or more trading entities for receiving a trade order;

FIG. 4 illustrates a flowchart representing a method performed by a server processing system for determining trading entities for receiving a trade order;

FIG. 5 illustrates a more detailed flowchart representing a method performed by the server processing system for determining one or more trading entities for receiving a trade order;

FIG. 6 illustrates a block diagram representing data stored in the database which is accessible by the server processing system;

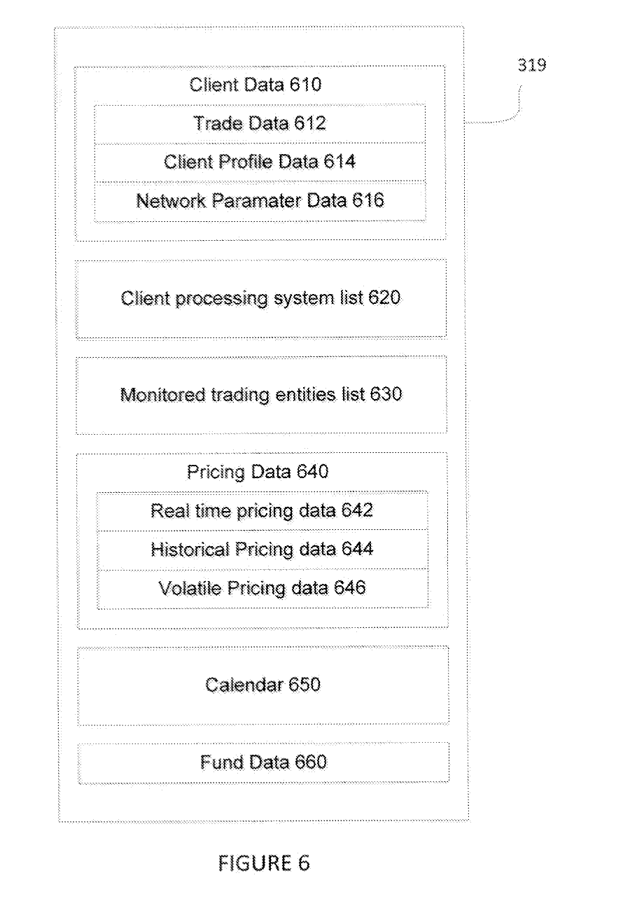

FIG. 7 illustrates a flowchart representing a method performed by the server processing system for managing a fund and trading system; and

FIG. 8 illustrates an example of fund data including various datum.

### DETAILED DESCRIPTION

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

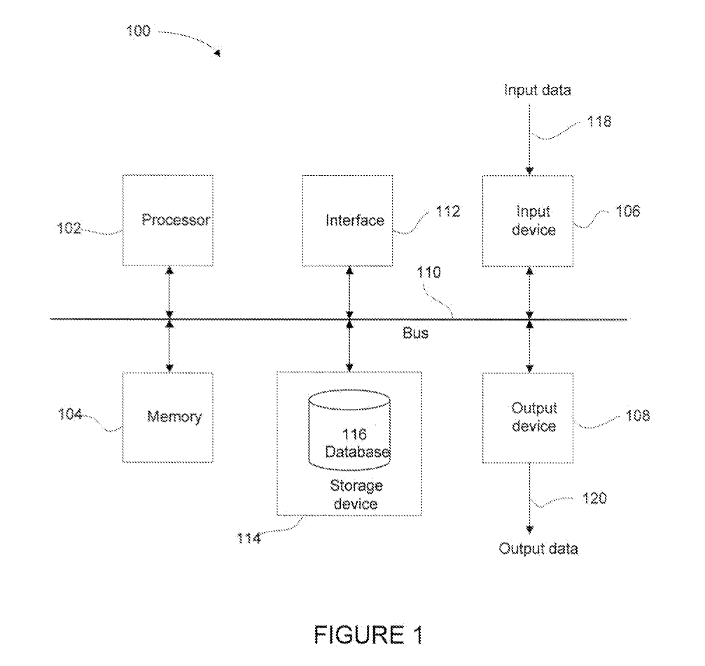

A particular embodiment can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

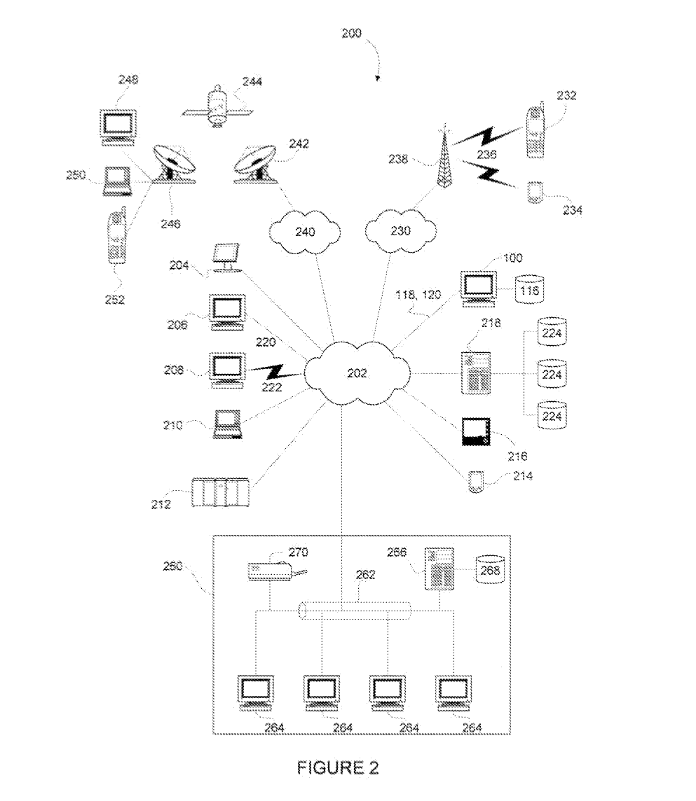

The processing device 100 may be a part of a networked communications system 200, as shown in FIG. 2. Processing device 100 could connect to network 202, for example the internet or a WAN. Input data 118 and output data 120 could be communicated to other devices via network 202. Other terminals, for example, thin client 204, further processing systems 206 and 208, notebook computer 210, mainframe computer 212. PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing device 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

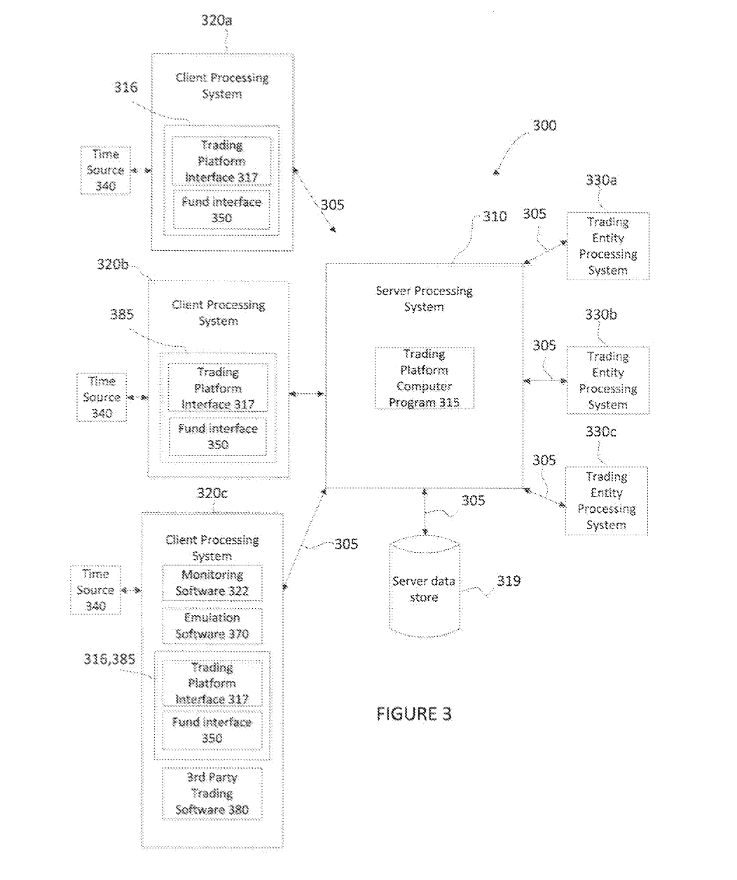

Referring to FIG. 3 there is shown a system diagram illustrating a system 300 for recommending a trading entities 340 for receiving trade orders.

In particular, the system 300 includes a server processing system 310 in data communication with a plurality of client processing systems 320a, 320b, 320c (generally referred to as 320) operated by respective users.

Each client processing system 320 may be in data communication with one or more trading entity processing systems 330a, 330b, 330c such as a broker processing system or an ECN. When a trade order is placed by a user at one of the client processing systems, the trade order is received and then executed by the trading entity processing system 330.

As shown in FIG. 3, the server processing system 310 can operate as a central trading server processing system by centrally receiving trade orders from the plurality of client processing systems 320 and then distributing the received trade orders to the one or more trading entity processing systems 330 based on evaluating and determining which trading entity 330 is the most suitable for receiving the trade order. Data communication between the various processing systems of system 300 is performed via one or more computer networks 305 which can be a public network such as the Internet, a private network, or a combination of both. In alternate arrangements, the server processing system 310 may suggest the recommended trading entity 350 for the trade order which is sent from client processing system 320 to the trading entity processing system 350 without being relayed via the server processing system 310.

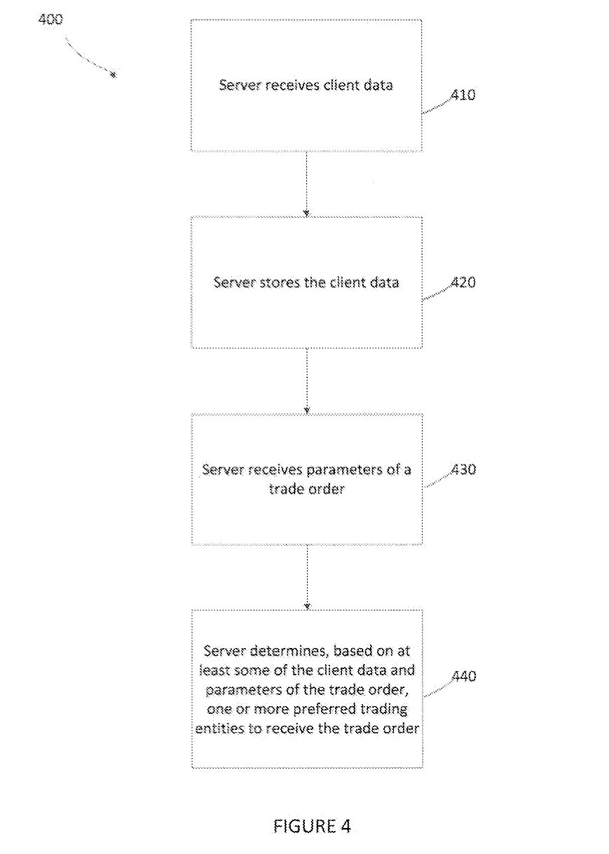

Referring to FIG. 4 there is shown a flowchart illustrating an example method 400 performed by the server processing system 310 for determining one or more trading entities 330 for receiving a trade order. The method 400 will be described in relation to the components of the system 300 and the data content of a data store 319, such as a database 319, accessible by the server processing system 310.

In particular, at step 410, the method 400 includes the server processing system 310 receiving client data 610 from a plurality of client processing systems 320, wherein the client data 610 received from each client processing system 320 includes trade data indicative of parameters of one or more trades by the respective user of the respective client processing system 320.

At step 420, the method 400 includes the server processing system 310 storing the client data 610 received from the plurality of client processing systems 320 in memory which is accessible by the server processing system 310. As illustrated in FIG. 3, the data 610 can be stored in a database 319 accessible by the server processing system 310.

At step 430, the method 400 includes the server processing system 310 receiving an indication that a trade order is to be placed by a user.

At step 440, the method 400 includes the server processing system 310 determining, based on the client data 610 of at least some of the client processing systems 320 and one or more parameters of the trade order, a trading entity 330 for receiving the upcoming trade order, thereby seeking to optimise the trade.

At step 450, the method 400 includes the trade orders being transferred to the determined trading entity 330 such that the trade is performed.

By using the trade parameters of the upcoming trade order and the client data 610 indicative of parameters of previous trades, the server processing system 310 can determine one or more trading entities 330 which can execute the upcoming trade order in a substantially optimal manner for the respective user. In particular, the server processing system 310 determines one or more preferable trading entities from the available trading entities which seek to optimise the profitability of the trade for the user.

The client data 610 includes trade data 612 indicative of parameters of previously executed trades. These parameters can be indicative of the trading entity 330 who executed the respective trade, a timestamp which trade orders were placed by the respective user at the client processing system 320, quoted pricing at the time the trade order was placed, actual pricing on order completion, and total time to process the trade.

The client data 610 may additionally be indicative of network parameters 616 of the network utilised by the client processing system 320 and the one or more trading entities 330. For example, the network properties may include network latency and link type. For example, the link type could be used to determine whether the client data collected is applicable to that link type, such as a user connected via 3G/GPRS in the same geographical location as another on ADSL may have differing optimal brokers. In addition, the network parameters may be indicative of a link provider. In particular, the link provider can be used in the determination of an optimal broker for a user, for example not all 30 networks are of the same signal strength in each area.

The collection of the client data 610 by the server processing system 310 can be performed using one or more techniques.

In particular, in some instances one or more of the client processing systems 320c can have installed therein monitoring software 322 for detecting and collecting the client data 610 which is input via a third party trading software 380. The monitoring software 322 generally collects the trade data 612 input via the trading software 380 which is transferred to the trading platform computer program 315 executing in memory of the server processing system 320. The monitoring software 322 executed upon client processing system 320 can utilise exposed functions or routines as part of an application programming interface of the trading software 380 to collect the client data 610. Additionally or alternatively, the monitoring software 322 can utilise code injection and/or API hooking to collect the client data 610 upon detection of a trade order being placed via trading software 380 installed and used upon the client processing system. Additionally or alternatively, the monitoring software 322 can perform a direct or indirect screen capture performed by a peripheral device or separate device to the client processing system 320, wherein image analysis is performed by the client processing system 320 or the server processing system 310 to capture the client data 610. Additionally or alternatively, the monitoring software 322 can perform network protocol analysis to collect the client data 610. As would be appreciated, various combinations of these techniques can be performed by the monitoring software 322 to collect the client data 610.

Preferably, upon detection of new client data 610 by the monitoring software 322, the client processing system 320 transfers the client data 610 to the server processing system 310 if possible. It is possible that only a subset of the client data 610 collected by each client processing system 320 may be transferred to the server processing system 310. It is also possible that the client data 610 may be periodically deleted by each client processing system 320 after a temporal threshold with respect to the time is was recorded. In other arrangements, the client data 610 can be stored in the non-volatile memory of the respective client processing system 320c. The client data 610 can then be periodically transferred from each client processing system 320 to the server processing system 310 for storage in the database 319. However, it is also possible for client data 610 to be transferred from each client processing system 320c on-demand in response to receiving a request from the server processing system 310, wherein the server processing system maintains in the database 319 a client processing system list 620 indicative of the client processing systems 320 to send a request for client data 610. Alternatively,

In additional or alternate arrangements, the client processing system 320a can have a trading platform computer program 316 installed in memory which presents the trading platform interface 317 which the user can interact therewith, wherein input trade order parameters are transferred to the server processing system 310 for storage in database 319.

In another example, as shown with respect to client processing system 320b, the trading platform interface 317 can be provided in the form of a web-based trading interface 317 which is presented via a web-browser 385, or web browser-like rich client application with system functions (such as direct hardware access), at the client processing system 320b. Again, trade order parameters are transferred to the server processing system 310 via the web-based interface 317 for storage in database 319.

At least some of the client processing systems 320 are time synchronised with a time source such that the temporal parameters of the client data 610 have a high resolution, thereby providing significant accuracy in assessing the performance of the monitored trading entities. The time source 340 can be a dedicated hardware device which is in communication with the respective client processing system 320 to obtain an accurate timestamp for temporal properties of the client data 610. One such dedicated hardware device 320 may be a GPS enabled device such as a GPS enabled mobile phone which can gather, decode and retransmit satellite timestamp data to the respective client processing system 320. An alternate dedicated hardware device 320 may be a high precision atomic clock which is accessible by the respective client processing system 320.

Temporal parameters of the client data 610 can be adjusted for network latencies. This adjustment can be calculated and performed by the respective client processing system 320, the time source 340, the server processing system 310, or a combination thereof. This adjustment seeks to remove temporal losses which may not be necessarily attributed to performance of the receiving trading entity 330, thereby providing data which can be more fairly evaluated to assess the performance of the monitored trading entities 330.

High accuracy of the temporal parameters of the client data 610 can be achieved by employing GPS anti-spoofing techniques. In one form, a prompt can be presented to the user via the display of the respective client processing system 320 upon commencement of their trading session. The prompt requests confirmation from the user of the physical location of the time source 340, wherein the prompt displays the perceived physical location of the time source 340 based on client processing system 320 querying the location of the time source 340. In the event that client processing system 320 detects that the perceived physical location moves or drifts from the confirmed physical location by a threshold distance, a subsequent prompt is presented by the monitoring software 322, the trading platform computer program 316 and/or browser 385 requesting reconfirmation of the location of the time source 340.

The client data 610 gathered by each client processing system 320 can additionally be indicative of a profile of the respective client processing system 320. The profile is a fingerprint or signature of the hardware and software environment of each client processing system 320. Example profile parameters that are collected include:
CPU type, model and clock speed
Operating system name and version
Trading terminal name and version
Total and free system memory
Total and free system storage space
Active network card type and model
Location
ISP
Installed and running software
Attached peripherals

In addition, the same profile properties of the time source 340 can be collected as well as the type of connection between the time source 340 and the client processing system 320.

In addition, the server processing system 310 gathers, requests and stores pricing data 640 indicative of real time pricing data 642 as well as historical pricing data 644 for each trading entity 330 that is available for selection. In particular, real time pricing data 642 can be requested by the server processing system 310 from the trading entity processing systems 330 and over time historical pricing data 644 can be generated and stored by the server processing system 310.

The server processing system 310 can also maintain in memory such as the database 319 a calendar 650 of known events for particular financial instruments available for trade. For example, the server processing system 310 may include in the calendar dates and times which expected company announcements are to occur, elections, etc. These events generally result in volatility in the market which trading entities 330 may take advantage thereof via increased profit margins. In order to assess trading entities 330 during these volatile periods, the server processing system 310 is scheduled to obtain and record real pricing data from at least some of the monitored trading entity processing systems for a pre-determined temporal window around a volatility event stored in the calendar. The collected volatile pricing data 646 can be stored in the database 319 accessible by the server processing system 310.

In addition, the server processing system 310 can react to unexpected volatility events. In particular, the server processing system 310 can be configured to detect unexpected volatility events via the use of online social media. The server processing system 310 can be configured to utilise a Bayesian inference function to detect an unexpected volatility event. Specifically, the trading platform computer program may include a volatile event detection module which utilises the Bayesian inference function. Upon successful detection, the server processing system 310 obtains from the monitored trading entity processing systems 330 current pricing data for evaluating each monitored trading entity 330 during an unexpected volatile event for the market.

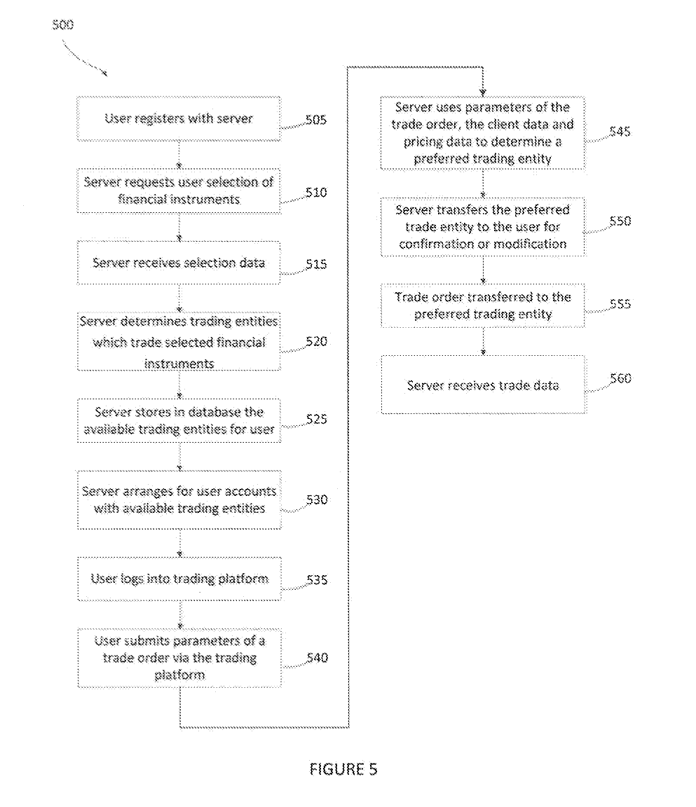

Referring to FIG. 5 there is shown another flowchart of an example method 500 performed by the system of FIG. 3.

In particular, at step 505 the method 500 includes a user of a client processing system 320 registering with the server processing system 310. Registration can be performed via interaction with a server 310 hosted website presented via a browser although it could also be performed via the client application 316 installed at the client processing system 320.

In order for the user to register with the server processing system 310, the user is required to provide proof of identity information. The proof of identity information is used by the server processing system 310 to ensure that the account is registered for a legitimate person or entity. Additionally, as will be explained in later steps, the proof of identity information is used for establishing accounts with each available trading entity 330 for the user. The user is additionally required to arrange transfer of funds to a user funds account managed or associated with the server processing system 310, wherein the transferred funds are available for the user to fund trades.

The server processing system 310 can compensate each user that enables client data to be collected. The compensation may be based upon the amount of monitoring/data collected by the client processing system 320. Additionally or alternatively, the compensation may be based upon the number of transactions recorded. Additionally or alternatively, the compensation may be based on how regularly information is collected and total duration (e.g N transactions recorded over the course of hours/days/years and the average time intervals in between them). Compensation may be in the form of providing access to a dynamically generated ranked list of trading entities 330 for receiving a trade order to optimise the trade, providing access to the trading platform 315 operated by the server processing system 310, virtual or real currency, or any combination thereof; as will be discussed in more detail below.

At step 510, the server processing system 310 requests a selection of financial instruments which the user would like to trade.

At step 515, the server processing system 310 receives selection data indicative of the financial instruments which the user would like to trade from the respective client processing system 320.

At step 520, the server processing system 310 queries the database 319 to determine relevant trading entities from a list of monitored trading entities 630 which are able to execute trades based on at least some of the selected financial instruments indicated by the user. The determined monitored trading entities can be reported to the user. The user can make refinements to the list of monitored available trading entities such as removing or adding one or more specific trading entities from/to the list.

At step 525, the server processing system 310 stores in the database 319, data indicative of the relevant monitored trading entities for the user based on the selected financial instruments for trade.

At step 530, the server processing system 310 may arrange for trading entity accounts to be established and registered with each relevant available trading entity 320 for the user. This process can be performed in a semi-automated manner. In particular, the server processing system 310 submits an encrypted and cryptographically signed request to each provider such as:

Account: (NEW|DELETE)
Type(s): (STOCKS|FUTURES|FOREX|COMMODITIES.....)
Personal details: .......
Proof of ID: ..... [files]
Confirmed by: [AGENT]

Once the accounts have been registered with each trading entity 320, the user is ready to submit one or more trade orders via the trading platform 315 such that the server processing system 310 optimises the one or more executed trades by determining one or more optimal trading entities 330 from the plurality of available trading entities for the user which act upon and execute the one or more trade orders. It will be appreciated that the user may already have an account setup with particular trading entities and therefore the establishment of a new account may be unnecessary in these instances.

At step 535, the user logs into the trading platform computer program 315. Login details such as username and password may be submitted to the server processing system 310 via the trading platform interface 317 in an encrypted manner such that the server processing system 310 can verify the identity of the user operating the client processing system 320. Upon login, the user is presented with various information such as totals and breakdowns of account balances, live quotes from the available trading entities, level of confidence in realising actual quoted prices per trading entity, cross trading entity arbitration opportunities based on current user profile, historical timed movements collected from users, correlations in between traded instruments, and recent and upcoming known events as per the calendar 650.

At step 540, the user submits parameters of a trade order via the trading platform interface 317 such that the parameters are transferred to the server processing system 310.

At step 545, the server processing system 310 is configured to use the parameters of the trade order, at least some of the client data and the pricing data to determine one or more trading entities 330 to receive the trade order thereby seeking to optimise the trade when executed. In particular, the server processing system 310 can be configured to calculate pricing properties for the relevant trading entities. The pricing properties can include pricing differentials, inefficiencies, and/or slippage.

The server processing system 310 may automatically select a subset of the client data 610 stored in the database 319 for use in determining the one or more optimal trading entities from a plurality of trading entities for receiving the trade order. In particular, the server processing system 310 initially determines the profile of the client processing system 320 placing the order. The server processing system 310 then selects client data 610 stored in the database 319 which has been received from client processing systems 320 which share a similar profile to the ordering client processing system 320. The subset of client data 610 is then used in combination with the parameters of the trade order and the pricing data 640 (real time and/or historical) to generate the ranked list of trading entities 330 for receiving the trade order. It will be appreciated that the ranked list generated can be different each time an indication of a new trade order is received due to the client data 610, the parameters of the trade order and the real time data can differ, thus a differently optimised trading entity can be used for executing the trade for the user.

For example, the server processing system 310 may determine the similarity of profiles based upon geographic location, network link type and latency, CPU and RAM utilisation when a trade was performed. Hardware type (e.g desktop, laptop, smartphone, tablet) and operating system versions and other applications installed (including their versions) and currently executing can also be used in this determination. In cases where no subset of data is able to be determined based on these attributes the server processing system 310 widens the search criteria until an appropriate subset is gathered which meets or exceeds a subset threshold stored in memory of the server processing system 310. For example, widening of geographic location matching from street to suburb, then to city, then to state and then to country. Alternatively allowing the subset of client data 610 to include any geographic location, as long as link latency and hardware types are within specified (and optionally widening) thresholds. The subset of client data 610 may also be determined to include trades performed under conditions of similar volatility based on the server processing system's 310 calendar of events.

The server processing system 310 can analyse the subset of client data 610 and sort trading entities by attributes such as:
Entities with the lowest latency order execution
Entities with the most optimal bid-offer spread
Entities with the least slippage
Entities with the appropriate liquidity (i.e actually able to fill the order)
Identifying arbitrage opportunities where known pricing adjustments for that particular instrument or pair have yet to propagate to all entities.

The server processing system 310 can use the volatile pricing data 646 in the event that the trade order is to be placed within a temporal threshold of an expected volatility event or the trade order is to be placed whilst an unexpected volatility event has been detected. The volatile pricing data 646 may be more heavily weighted than normal pricing data of available trading entities in these circumstances or alternatively the evaluation may be solely performed only using volatile pricing data rather than normal pricing data.

The server processing system 310 can additionally be configured to select more than one trading entity 330 from the available trading entities for the user, wherein the trade orders are divided by the server processing system 310 between the multiple selected trading entities 330 to optimise the trade. The placement of the trade orders using multiple trading entities can reduce the risk of the entire trade being executed in an unoptimised manner. The division of the trade orders by the server processing system 310 may be performed evenly although the server processing system 310 may additionally weight the division of the trade orders according to the evaluation of the selected trade entities 330.

For example, the server processing system 310 may include predetermined trade order division data which is applied to the ranked list of trading entities. For example, the predetermined trade order division data may apply 40 percent of the trade order to the first ranked trading entity. 30 percent of the trade order to the second ranked trading entity, 20 percent of the trade order to the third ranked trading entity, 5 percent of the trade order to the fourth ranked trading entity and 5 percent of the trade order to the fifth ranked trading entity. Alternatively, some of the divisions may be randomly generated. For example, 25 percent of the trade order is applied to the first ranked trading entity, however the remaining 75 percent is randomly determined for a remaining number of trading entities to be used to execute the trade order. In another arrangement, the trade order may be staggered. For example, 25 percent of the trade order may be applied to the first ranked trading entity, wherein after the trade is completed, the server processing system 310 determines the actual pricing/slippage information and then using historical data for the remaining trading entities regarding time frames to react and update their prices, the server processing system 310 may split the remaining 75 percent of the trade order the in the most beneficial manner. More specifically, if 25 percent of the trade order is sent to the first ranked trading entity which results in a slippage of $100, the server processing system can determine that the third and eighth ranked trading entities are slowest to react to changed pricing, therefore the server processing system applies the remaining 75 percent of the trade order to be split between the third and eighth ranked trading entities.

At step 550, the server processing system 310 may transfer to the respective ordering client processing system 320 the determined one or more optimal trading entities 330 selected from the available trading entities for the user based on at least parameters of the trade order. The user can then provide input using the input device of the client processing system 320 to confirm that the one or more determined trading entities are to be used for executing the trade orders. Alternatively, the user may modify or override the selection of the one or more trading entities for receiving the trade order.

It will be appreciated that step 550 is optional. In particular configurations, the user may store settings in their account data indicating that no confirmation or adjustment is to be made by the user with regard to the one or more trading entities selected for optimising the execution of the trade. Therefore, in these circumstances, step 550 is not performed.

At step 555, the trade order is placed with the determined one or more trading entities 330. This can be done in a number of manners.

In one form, the server processing system 310 can transfer the trade order to the trading entity processing system 330 without the user having to transfer the trade order directly to the trading entity processing system 330. In one form, trading platform computer program 315 executing upon the server processing system 310 can utilise the FIX protocol to place trade orders with determined trading entities. For example, if a user has an account with Trading Entity X and the server processing system 310 is able to transfer a trade order to Trading Entity X, then the server processing system can send the user's trade order (initiated by the user via our server processing system) to Trading Entity X on behalf of the user using the FIX protocol or another appropriate protocol.

In cases where the trade order is to be directly placed by the with the trading entity by the user, the platform computer program 315 could signal the user's local instance of trading software 380 to forward the trade orders to the trading entity processing system 330. This could be achieved by way of a common API/SDK available for the trading software 380 of the client processing system 320 or alternatively by utilising code injection/API hooking in relation to the trading software 380. In another variation, the client processing system 320 may have installed thereon emulation software 370 that is initiated by the server processing system 310 to emulate network traffic of the trading entity's software such that the trade order is transferred to the trading entity processing system 330 via the respective client processing system 320 and the respective trading software 380.

At step 560, the server processing system 310 receives trade data from each of the relevant trading entities 330 (potentially via the monitoring software 322 in the event that the trade order was placed directly via the client processing system 320) confirming that the trades were performed. The server processing system 330 updates the user's account to reflect that the trade has been executed. It will be appreciated that the trade data from these trades can be stored in the database 319 so it can be used for determining the relevant trading entities 330 to receive future trade orders.

Users of the trading platform computer program 315 can be ranked both publicly and privately on a number of metrics such as turnover, number of trades, daily/monthly/yearly change, percentage of gains versus percentage of losses, overall trading style and so on. As such, the trading platform interface 317 can display to users the ranked list. However, it will be appreciated that users can define in settings data of the user's account that they do not want to be publicly displayed in rankings by the server processing system 310.

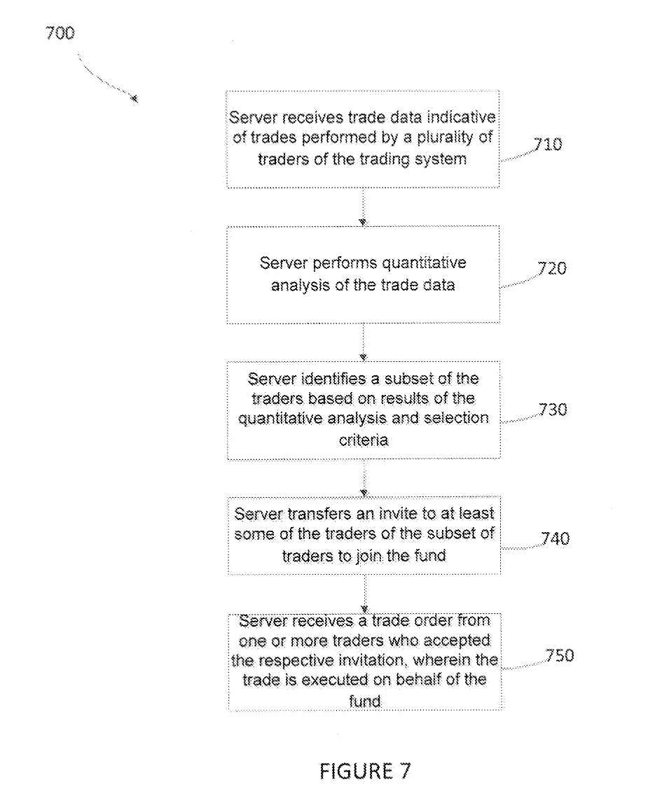

The trading platform computer program 315 executed by the server processing system 320 can also operate a fund system. In particular, referring to FIG. 7 there is shown a flowchart which illustrates a method that the server processing system 310 manages the fund and trading system. In particular, at step 710, the method 700 includes the server processing system 310 receiving trade data 612 indicative of trades performed by a plurality of traders of the trading system. At step 720, the method 700 includes the server processing system 310 performing quantitative analysis of the trade data 612. At step 730, the method 700 includes the server processing system 310 identifying a subset of the traders based on results of the quantitative analysis and selection criteria. At step 740, the method 700 includes the server processing system 310 transferring an invite to at least some of the traders of the subset of traders to join a fund managed by the server processing system 310. At step 750, in the event that at least one of the traders joins the fund, the method 700 includes the server processing system 310 receiving a trade order from the at least one of the traders for execution on behalf of the fund. In one form, the trade order is received from a client processing system 320 in data communication with the server processing system 310.

Advantageously, the fund may provide hedge fund-like advantages to retail investors who are not classified as ‘sophisticated’ or ‘accredited’ and thus would otherwise be unable to access such investment vehicles via an online platform in a clear and easy to understand manner.

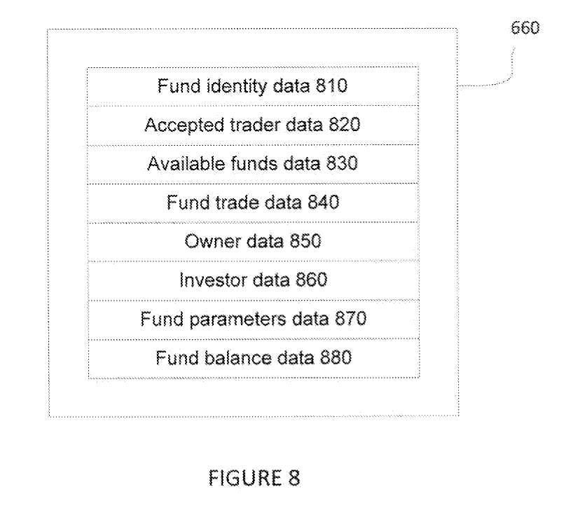

Referring to FIG. 8 there is shown various datum of the fund data 660. In particular, the database can include fund data for each fund that is managed by the server processing system 310. The fund data 660 for a respective fund can include fund identity data 810 indicative of the identity of the respective fund, accepted trader data 820 indicative of the traders who have accepted to submit trade orders for execution by the fund, available funds data 830 indicative of the real and virtual currency available for the fund to trade, fund trade data 840 indicative of trades executed by the fund, owner data 850 indicative of the owners of the fund (including owner profile and owner picture, description of owner experience, owner trading style, etc) investor data 860 indicative of identities of investors in the fund, portfolio data indicative of a present and past portfolio of the fund, fund parameters data 870 (i.e. minimum deposit, minimum investment term, management fee, performance fee and objectives), and fund balance data 880 indicative of the balance of the fund.

Users can register with the trading platform computer program 315 via a fund interface 350 to participate in the fund system such that funds can be established by at least some of the users as well as allowing at least some users to join particular funds. The fund interface 350 can be part of the trading platform computer program 316 as shown in relation to client processing system 320a. Alternatively, the fund interface 350 can be a website hosted by the server processing system 310, wherein the fund interface 350 is presented via a browser 385 at the client processing system 320. It will be appreciated that the interfaces 317, 350 can be part of the same website in this arrangement. Users can register to participate with the fund system via interaction with the fund interface 350 similarly as described above.

A user or group of users can interact with the server processing system 310 via the fund interface 350 presented via one or more client processing systems 320 to establish a fund, wherein the establishing user(s) are herein referred to as the owner of the fund. The owner of a fund can define parameters of the fund such as the minimum deposit, the minimum investment term, the management fee, the performance fee, operating style (i.e conservative, aggressive, hedged . . . ) and objectives. These details are stored in the database as fund parameters data 870 of the fund data 660 of the server processing system 319. Details of the owner of the fund can be defined and stored in the server processing system database 319 as owner data 850 including the owner profile, the owner picture, the description of owner experience, the owner trading style, fund aim, etc.

Other users who are not the owner are able to invest in the fund via interaction with the fund interface 350 at the respective user client processing system 320. Data indicative of investments 860 are stored in the fund data 660. However, a fund should preferably reach and maintain a certain number and percentage of profitable trades under various market conditions before the trading platform program enables other users to invest in the respective fund.

Owners of a fund may directly deposit real or virtual funds into the fund via the fund interface 350 presented via the client processing system 320. Preferably, owners never have direct access to users funds who have invested in the fund.

The trading platform program 315 maintains and tracks real and virtual balances 880 for each fund. The owner(s) may select a consolidated view in the platform interface displaying the total of actual and virtual currency. In these cases each trade can be automatically split between actual and virtual currency trades according to a defined ratio in the fund data 660.

Virtual currency is used to enable gathering of performance metrics for new funds that would otherwise have low or zero balances. Additionally, virtual currency allows purchase or access to data, platform access and/or other services.

Funds are ranked both publicly and privately on a number of metrics such as turnover, number of trades, daily/monthly/yearly change, percentage of gains versus percentage of losses, number of users, overall trading style and so on. In one configuration, funds may opt out of certain but not all public rankings. Any virtual currency trades are emulated and modelled as closely as possible to real-world conditions.

The trading platform computer program 315 executing upon the server processing system 310 can attempt to locate actual trades that were performed under almost identical conditions that are stored in the database 319 and apply their results or skew execution appropriately when calculating results of virtual transactions for funds. It will be appreciated that past trades could include trades that have occurred only microseconds prior to the receipt of the trade orders for the virtual transaction.

As outlined above, the trading platform computer program 315 may automatically transfer an invitation to one or more highly ranked users to join a specific fund. In particular, the server processing system 310 can be configured to generate a ranked list of traders based on quantitative analysis of actual and modelled trader behaviour. A subset of the traders from the ranked list can then be selected by the server processing system 310 based on selection criteria which can be defined based on the objectives of the fund. The server processing system 310 can then transfer an invite to at least some of the traders of the subset of the ranked list of traders to join a fund managed by the server processing system 310. The invite may be a message presented via the fund interface 350. Alternately, an electronic message such as an email may be transferred to the trader, wherein the electronic message includes a hyperlink for selection to accept the invitation.

In the event that a trader accepts the invitation, the trader can place his trade order via the trading platform interface 317 wherein the monitoring software 322 detects and forwards details of the trade order to the trading platform computer program 315 for execution on behalf of the fund. Alternatively, the trader can place the trade order via the fund interface 350. As will be appreciated from above, personal trade orders which the trader places can then be executed for the fund. Therefore, the trader does not need to indicate whether the trade order is a personal trade or a trade on behalf of the fund as effectively the trade parameters of the trade order are shared, although the amount of funds invested on behalf of the fund may be adjusted based on the amount of funds associated with the fund and/or a defined limit on the amount of funds used for a trade which is setup by the owner of the fund. However, in alternate arrangements, the trader can selectively indicate a particular trade order is a personal trade only or trade order for the fund via the fund interface 350 wherein the trading platform computer program 315 executes the trade order only if the trader has indicated that the trade order is on behalf of the fund. Alternatively, the trader may switch into ‘fund mode’ where all trades are only executed for the fund. This may be achieved by a simple UI widget such as a switch or dropdown list or by signing into the trading platform using the trader's fund specific login details.

The server processing system 310 can be configured to rank and select traders for the purposes of the invitation based on various criteria. Each fund can be defined with particular objectives 870 as discussed above, wherein the server processing system 310 uses the defined objectives 870 of the respective fund to identify the traders to invite to the fund. For example, the server processing system 310 could identify traders based on a total ratio of profitable trades and/or actual profits. The server processing system 310 can apply the selection criteria to results of quantitative analysis automatically performed upon actual and modelled trader behaviour using the trade data stored in database 319 to identify the subset of the traders for issuing an invite. For example, the server processing system 310 can be configured to automatically use one or more of the following techniques in order to identify the subset of traders for the respective fund:
Multidimensional analysis on historic trades and comparing to others;
Data clustering algorithms to group users into similar groups based on past behaviour;
Hidden Markov model analysis based on trader behaviour;
A self organizing map (SOM) of traders;
One or more pattern recognition algorithms on performed trades; and
Any number of signal processing algorithms, for example vector quantization.

It will be appreciated by those skilled in the art that other algorithms, models and techniques can be used for selecting a subset of traders for invitation to a respective fund.

Preferably, the server processing system 310 is configured perform quantitative analysis in respect of the traders to model their behaviours instead of the movements of underlying instruments in order to seek ideal or preferred traders to invite which substantially match the fund's objective(s). Due to the high-resolution dataset stored in the database 319 as discussed in previous embodiments, such modelling and analysis is possible with high degrees of accuracy. The parameters and algorithms used to determine a subset of traders may vary depending on the stated objectives of each hosted fund. The owner of the fund can provide input data when defining the fund to select the objectives from a list of objectives which result in a selection of quantitative analysis functions for use by the server processing system 310 in identifying the subset of traders. Alternatively, the owner of the fund can input a selection of the specific quantitative analysis functions which are to be used to identify the subset of traders. The system may also be configured to periodically identify, in a fully or semi-automatic manner, a subset of users recommended for invitation to a particular fund.

The owner can define a form of compensation provided to offer to the selected recommended users to take part in the fund. The automatic invite may be transferred automatically or semi-automatically where the trading platform computer program 315 suggests one or more users which are recommended for receiving an invitation. The owner(s) of the fund can then confirm that the invitation can be transferred or not to the recommended user.

The trading platform computer program 315 is configured to receive and store, in the database 319, investment criteria which is stored as part of the fund data 660 for each user participating in the fund system. The investment criteria can include such criteria as a timeframe and whether the user values a slightly lower performing conservative fund or a high performance high risk fund. The trading platform computer program 315 can then generate a ranked list of funds managed through the fund system based upon the user defined investment criteria. The computer program 315 then tentatively allocate currency from the user's account into each respective fund. Actual automatic allocation can be executed after a pre-configured time delay in the range of several seconds to days, during which the user has the ability to view, modify or cancel any of the automatic allocations.

Users may opt to manually select any amount of funds to invest in or allow the computer program 315 to automatically suggest a split of capital between any number of funds based on user preferences.

The server processing system 310 under control of the trading platform program 315 can automatically generate and distribute appropriate performance reports via interface 350 to users of the fund system. The trading platform program 315 also automatically alerts the user via interface 350 when the minimum investment term for one or more funds is approaching.

The server processing system 310 under control of the trading platform program 315 also suggests via the fund interface 350 other funds to users, for example funds with a higher return, up and coming funds, funds in a different risk profile and so on.

Once the minimum investment term has been reached the server processing system under control of the trading platform program 315 allows each user to continue with their existing fund or re-allocate funds to another fund, either suggested by the trading platform program 315 or determined by the user.

The server processing system 310 can manage a plurality of funds, wherein the server processing system 310 can generate and maintain a ranked list of funds. A user of the trading system can be presented with the ranked list in order to decide a fund to select. In particular embodiments, the user can provide a selection criteria such as their investments strategy, wherein a subset of funds are selected by the server processing system 310 according to fund objectives, and the remaining subset of funds which satisfied the search criteria are then sorted and presented via the trading platform interface to the searching user via the client processing system 320.

In another embodiment, the server processing system 310 may implement ordering matching. For example, if a trader is placing a trade order to sell 10 units of coffee and another trader is placing a trade order to buy 8 units of coffee then the server processing system 310 may swap their holdings at the current most close-to-optimal detected price and only send out the trade order in respect of the difference (2 units) to a trading entity.

This application claims priority to and the benefit of U.S. Provisional Application No. 61/864,025, filed on Aug. 9, 2013, the entire disclosure of which is incorporated by reference herein.

Many modifications will be apparent to those skilled in the art without departing from the scope of the present invention.

1. A server processing system for determining a trading entity for receiving a trade order, wherein the server processing system is configured to:
receive client data indicative of trade data for one or more trades by one ore more users of one or more client processing systems;
store the client data in memory;
receive parameters of a trade order; and
determine, based on at least some of the client data stored in memory and parameters of the trade order, a preferred trading entity from a plurality of available trading entities to receive the trade order thereby seeking to optimise the trade, wherein the trade order is transferred to a trading entity processing system of the preferred trading entity to execute the trade.

2. The server processing system according to claim 1, wherein the trade data is indicative of:
one or more respective trading entities who executed the respective one or more previous trades;
a timestamp when one or more trade orders were sent to a respective trading entity for the one or more previous trades;
quoted pricing at the time the one or more trade orders were placed;
actual pricing for the respective one or more previous trades; and
total time to process the one or more trades.

3. The server processing system according to claim 1, wherein at least some of the client data is indicative of a client processing system profile for each client processing system, wherein the server processing system is configured to:
determine a subset of the client data based on the client processing system profile; and
determine the preferred trading entity based on the subset of the client data.

4. The server processing system according to claim 1, wherein the server processing system obtains pricing data from the plurality of available trading entities, wherein the server processing system is configured to determine the preferred trading entity further based on the pricing data.

5. The server processing system according to claim 4, wherein the server processing system is configured to obtain at least some of the pricing data from the plurality of available trading entities at scheduled or detected volatile events, wherein in the event that the server processing system receives parameters of a trade order for a new scheduled or current volatile event, the server processing system determines the preferred trading entity based on the pricing data obtained for the scheduled or the detected volatile events.

6. The server processing system according to claim 1, wherein the server processing system is configured to select multiple preferred trading entities from a plurality of available trading entities to receive the trade order.

7. The server processing system according to claim 6, wherein the server processing system is configured to divide the trade order between the multiple preferred trading entities:
equally; or
unequally based on an evaluation of the multiple preferred trading entities for the trade order.

8. The server processing system according to claim 1, wherein the server processing system is configured to manage a fund and trading system, wherein the server processing system is configured to:
perform quantitative analysis of the trade data, wherein the trade data is indicative of trades by a plurality of users;
identify a subset of the users based on results of the quantitative analysis and selection criteria;
transfer an invite to at least some of the users of the subset of users to join a fund managed by the server processing system; and
in the event that at least one of the users join the fund, receive the trade order from the at least one of the users using one of the client processing systems for execution on behalf of the fund.

9. A non-transitory computer readable medium for configuring a server processing system for determining a trading entity for receiving a trade order, wherein the server processing system is configured by the computer readable medium to:
receive client data indicative of trade data for one or more trades by one ore more users of one or more client processing systems;
store the client data in memory;
receive parameters of a trade order; and
determine, based on at least some of the client data stored in memory and parameters of the trade order, a preferred trading entity from a plurality of available trading entities to receive the trade order thereby seeking to optimise the trade, wherein the trade order is transferred to a trading entity processing system of the preferred trading entity to execute the trade.

10. The computer readable medium according to claim 9, wherein the trade data is indicative of:
one or more respective trading entities who executed the respective one or more previous trades;
a timestamp when one or more trade orders were sent to a respective trading entity for the one or more previous trades;
quoted pricing at the time the one or more trade orders were placed;
actual pricing for the respective one or more previous trades; and
total time to process the one or more trades.

11. The computer readable medium according to claim 9, wherein the client data is indicative of a client processing system profile, wherein the server processing system is configured to:
determine a subset of the client data based on the client processing system profile; and
determine the preferred trading entity based on the subset of the client data.

12. The computer readable medium according to claim 9, wherein the server processing system is configured to obtain pricing data from the plurality of available trading entities, wherein the server processing system is configured to determine the preferred trading entity further based on the pricing data.

13. The computer readable medium according to claim 12, wherein the server processing system is configured to obtain at least some of the pricing data from the plurality of available trading entities at scheduled or detected volatile events, wherein in the event that the server processing system receive parameters of a trade order for a new scheduled or current volatile event, the server processing system determines the preferred trading entity based on the pricing data obtained for the scheduled or the detected volatile events.

14. The computer readable medium according to claim 9, wherein the server processing system is configured to select multiple preferred trading entities from a plurality of available trading entities to receive the trade order.

15. The computer readable medium according to claim 14, wherein the server processing system is configured to divide the trade order between the multiple preferred trading entities:
equally; or
unequally based on an evaluation of the multiple preferred trading entities for the trade order.

16. The computer readable medium according to claim 9, wherein the server processing system is configured to manage a fund and trading system, wherein the server processing system is configured to:
perform quantitative analysis of the trade data, wherein the trade data is indicative of trades by a plurality of users;
identify a subset of the users based on results of the quantitative analysis and selection criteria;
transfer an invite to at least some of the users of the subset of users to join a fund managed by the server processing system; and
in the event that at least one of the users join the fund, receive the trade order from the at least one of the users using one of the client processing systems for execution on behalf of the fund.

17. A server processing system for managing a fund and trading system, wherein the server processing system is configured to:
receive trade data indicative of trades performed by a plurality of traders of the trading system;
perform quantitative analysis of the trade data;
identify a subset of the traders based on results of the quantitative analysis and selection criteria;
transfer an invite to at least some of the traders of the subset of traders to join a fund managed by the server processing system; and
in the event that at least one of the traders joins the fund, receive a trade order from the at least one of the traders for execution on behalf of the fund, wherein the trade order is received from a client processing system in data communication with the server processing system.

18. The server processing system according to claim 17, wherein the trades are executed using actual or virtual currency.

19. The server processing system according to claim 18, wherein in the event that the trade is to be executed using virtual currency, the server processing system is configured to:
identify, from the trade data, one or more executed trades using actual currency which are similar to the requested trade; and
use results of the identified executed trades using actual currency to simulate the trade using virtual currency.

20. The server processing system according to claim 17, wherein the server processing system is configured to transfer the invite:
automatically; or
in response to receiving approval from the owner.
